(19) United States
(12) Patent Application Publication
(10) Pub. No.: US 2007/0020164 A1
(43) Pub. Date: Jan. 25, 2007

(54) Process for producing fine metal oxide particles

(76) Inventors: Takashi Tani, Kawasaki-shi, Kanagawa (JP); Makoto Saito, Kawasaki-shi, Kanagawa (JP); Takashi Ueda, Kawasaki-shi, Kanagawa (JP); Keiichi Nakamura, Kawasaki-shi,Kanagawa (JP); Tomofumi Nishimura, Kawasaki-shi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/570,138

(22) PCT Filed: Aug. 6, 2004
(86) PCT No.: PCT/JP04/11641

§ 371 Date: Mar. 1, 2006

Related U.S. Application Data
(60) Provisional application No. 60/567,011, filed on May 3, 2004.

(30) Foreign Application Priority Data
Sep. 1, 2003 (JP) 2003-309092

(51) Int. Cl. C01F 17/00; C09K 11/77; C09K 11/54; C09K 11/08; H01B 1/12

(52) U.S. Cl. 423/263; 252/301.4 R; 252/301.6 F; 252/500

(57) ABSTRACT

The present invention provides a process for producing fine metal oxide particles efficiently and simply. The process for producing fine metal oxide particles of the present invention comprises subjecting a gaseous organometallic compound to combustion in a gas phase in the presence of an oxidizing substance; mixing a gaseous organometallic compound with an oxidizing substance to prepare a mixture and subjecting the mixture to combustion; mixing an organometallic compound solution with an oxidizing substance to prepare a mixture making the mixture into a gaseous state and then subjecting the gaseous mixture to combustion; or mixing an oxidizing substance with a gaseous organometallic compound prepared by vaporizing an organometallic compound solution to prepare a mixture and subjecting the mixture to combustion.

### CROSS-REFERENCE TO RELATED APPLICATION

This application is an application filed under 35 U.S.C. §111 (a) claiming benefit pursuant to 35 U.S.C. §119(e) (1) of the filing date of Provisional Application 60/567,011 filed May 3, 2004 pursuant to 35 U.S.C. §111 (b).

### FIELD OF THE INVENTION

The present invention relates to a process for producing fine metal oxide particles, and more particularly, a process for producing fine metal oxide particles used for a phosphor, a catalyst, an abrasive, an electrically conductive transparent membrane or the like.

### BACKGROUND OF THE INVENTION

Fine particles of a metal oxide are used for a phosphor, a catalyst, an abrasive, an electrically conductive transparent membrane-or the like. Particularly, when fine particles are made to have a particle diameter of not more than 100 nm, the luminous strength, catalyst activity and polishing properties thereof are markedly improved. Therefore, the development of a process for producing fine metal oxides particles efficiently and simply has been desired.

As a process for producing fine particles of metal oxides, various processes are known. For example, as a process for producing fine particles by a chemical vapor deposition method, a process of using a metal halide and an oxidizing gas is known (for example, referred to JP-B-1033945), but has a problem in that a halide is produced and the resulting fine particles are contaminated by the halide and thereby the properties of the fine particles are deteriorated.

Further, there is a known process for producing fine metal oxide particles which process comprises vaporization of a liquid metal oxide precursor such as a metal halide or a metal alkoxide and then allowing to contact with an oxygen-containing gas in a gas phase and thereby conducting reaction thereof (for example, referred to JP-B-63-46002). The process, however, has a problem such that as the metal alkoxide is easily hydrolyzed, it is decomposed before the gasification and the yield thereof is low and further piping is clogged.

Furthermore, there is a known process for producing a metal oxide thin film or fine powders by heating a mixture of a β-diketonate metal complex and water vapor and hydrolyzing the complex (for example, referred to JP-A-57-118002 and JP-B-1845566). The process, however, is necessary to have troublesome procedures such that the flow rates of β-diketonate metal complex vapor, a carrier gas and water vapor are controlled to regulate a molar ratio thereof, and fine powders having a small diameter cannot be obtained stably.

It is an object of the present invention to provide a process for producing fine metal oxide particles efficiently and simply. The resulting fine particles of a metal oxide can be used for a phosphor, a catalyst, an abrasive, an electrically conductive transparent membrane or the like.

### DISCLOSURE OF THE INVENTION

The present inventors have been earnestly studied on the above subject, and found the process for producing fine metal oxide particles efficiently and simply. Thus, the present invention has been accomplished. That is, the present invention has the following particulars [1] to [25].

[1] The process for producing fine metal oxide particles of the invention comprises subjecting a gaseous organometallic compound to combustion in a gas phase in the presence of an oxidizing substance.

[2] The process for producing fine metal oxide particles of the invention comprises mixing a gaseous organometallic compound with an oxidizing substance to prepare a mixture and subjecting the mixture to combustion.

[3] The process for producing fine metal oxide particles of the invention comprises mixing an organometallic compound solution with an oxidizing substance to prepare a mixture, making the mixture into a gaseous state and subjecting the gaseous mixture to combustion.

[4] The process for producing fine metal oxide particles of the invention comprises mixing an oxidizing substance with a gaseous organometallic compound prepared by vaporizing an organometallic compound solution to prepare a mixture and subjecting the mixture to combustion.

[5] The process for producing fine metal oxide particles according to any one of the particulars [1] to [4] is characterized in that the oxidizing substance comprises at least one selected from an oxygen-containing gas, oxygen, water and nitrous oxide.

[6] The process for producing fine metal oxide particles according to any one of particulars [1] to [5] is characterized in that a combustion improver is used in the combustion of the organometallic compound and the oxidizing substance.

[7] The process for producing fine metal oxide particles according to any one of the particulars [3] and [4] is characterized in that the solvent of the organometallic compound solution is a combustion improver.

[8] The process forproducing fine metal oxide particles according to any one of the particulars [1] to [7] is characterized in that the organometallic compound comprises at least a metal, a carbon and a hydrogen atom.

[9] The process for producing fine metal oxide particles according to any one of the particulars [1] to [7] is characterized in that the organometallic compound comprises at least one compound selected from an alkyl metal compound, a metal alkoxide and a β-diketone metal complex.

[10] The process for producing fine metal oxide particles according to the particular [9] is characterized in that an alkyl group of the alkyl metal compound has 1 to 10 carbon atoms.

[11] The process for producing fine metal oxide particles according to the particular [9] is characterized in that the metal alkoxide is a metal methoxide, ethoxide, n-propoxide, i-propoxide, n-butoxide, sec-butoxide, tert-butoxide or t-amyloxide.

[12] The process for producing fine metal oxide particles according to the particular [9] is characterized in that the β-diketone metal complex is a metal complex of 2,2,6,6-tetramethylheptane-3,5-dione, 2,6-dimethyl-3,5-heptanedione or 2,4-pentanedione.

[13] The process for producing fine metal oxide particles according to any one of the particulars [3] and [4] is characterized in that the solvent of the organometallic compound solution is at least one solvent selected from methyl alcohol, ethyl alcohol, propyl alcohol, butyl alcohol, tetrahydrofuran, dimethyl sulfoxide, dimethylformamide, hexane, cyclohexane, methylcyclohexane, dioxane, acetone, ethyl acetate, butyl acetate, methyl isobutyryl ketone, diethyl ether, t-butyl methyl ether, acetyl acetone, diisobutyryl methane and dipivaloyl methane.

[14] The process for producing fine metal oxide particles according to any one of the particulars [1] to [13] is characterized in that the combustion temperature is not lower than 400° C.

[15] The process for producing fine metal oxide particles according to any one of the particulars [1] to [14] is characterized in that the oxidizing substance is used in a molar amount of from 0.5 to 40 times the molar amount of oxygen required for complete oxidization of the organometallic compound and the solvent of the organometallic compound solution.

[16] The process for producing fine metal oxide particles according to any one of the particulars [1] to [15] is characterized in that the fine metal oxide particles produced have a number average particle diameter of not more than 100 nm.

[17] The process for producing fine metal oxide particles according to any one of the particulars [1] to [16] is characterized in that the fine metal oxide particles produced are phosphors.

[18] The process for producing finemetal oxide particles according to the particular [17] is characterized in that the phosphor is at least one red phosphor selected from Y₂O₃:Eu, (Y, Gd)₂O₃:Eu, YBO₃:Eu and (Y, Gd)BO₃:Eu.

[19] The process for producing finemetal oxide particles according to the particular [18] is characterized in that the boron source of YBO₃:Eu or (Y, Gd)BO₃:Eu is a borate.

[20] The process for producing fine metal oxide particles according to the particular [17] is characterized in that the phosphor is at least one green phosphor selected from Y₂O₃:Tb, Zn₂SiO₄:Mn and (Mg, Sr, Ba)Al₁₂O₁₉:Mn.

[21] The process for producing fine metal oxide particles according to the particular [17] is characterized in that the phosphor is at least one blue phosphor selected from Y₂O₃:Tm and (Ba, Mg)Al₁₀O₁₇:Eu.

[22] The process for producing fine metal oxide particles according to any one of the particulars [1] to [16] is characterized in that the fine metal oxide particles produced are conductive materials.

[23] The process for producing fine metal oxide particles according to the particular [22] is characterized in that the conductive materials comprise tin oxide or tin oxide added indium oxide.

[24] The process for producing fine metal oxide particles according to any one of the particulars [1] to [16] is characterized in that the fine metal oxide particles produced are ferroelectric substances.

[25] The process for producing fine metal oxide particles according to the particular [24] is characterized in that the ferroelectric substances comprise barium titanate, strontium titanate, lead titanate, barium strontium titanate, lead zirconium titanate, lead lanthanum zirconium titanate or strontium bismuth tantalum oxide.

### BRIEF DESCRIPTION OF THE DRAWINGS

FIG. 1 is a schematic diagram showing one embodiment of a production apparatus used in the process for producing the fine metal oxide particles according to the present invention.

FIG. 2 is a schematic diagram showing another embodiment of a production apparatus used in the process for producing the fine metal oxide particles according to the present invention.

FIG. 3 is an electron microscopic photograph of red fluorescent fine particles prepared in Example 1.

### DESCRIPTION OF MARKS

1 . . . Oxidizing substance
2 . . . Carrier gas
3 . . . Carrier gas
4a, 4b, 4c and 4d . . . Mass flow controller
5 . . . Preheater
6 . . . Heating vaporizer
7 . . . Heating vaporizer
8 . . . Tubular electric furnace (Combustion apparatus)
9 . . . Collector
10 . . . Solution
11 . . . Metering pump
12a and 12b . . . Preheater

### PREFERRED EMBODIMENTS OF THE INVENTION

The process for producing the fine metal oxide particles according to the present invention will be described in detail hereinafter.

One of the characteristics of the present invention is production of fine metal oxide particles by the way of subjecting a gaseous organometallic compound to combustion in the presence of an oxidizing substance.

In the present invention, the organometallic compound preferably contains at least a metal, a carbon and a hydrogen atom, and specifically it is preferably an alkyl metal compound, a metal alkoxide or a β-diketone metal complex.

The alkyl metal compound used in the present invention is preferably an alkyl metal compound having an alkyl group of 1 to 10 carbon atoms, and examples thereof may include trimethyl aluminum, trimethyl indium and trimethyl gallium.

The metal alkoxide used in the present invention is preferably a metal methoxide, ethoxide, n-propoxide, i-propoxide, n-butoxide, sec-butoxide, tert-butoxide or t-amyloxide, and examples thereof may include tetramethoxy silane, tetraethoxy silane, tetra ethoxy titanium, tetra-i-propoxy titanium, tetra-t-butoxy zirconium, tetra-t-butoxy hafnium, pentaethoxy tantalum, tri-i-propoxy aluminum, triethoxy boron, di-t-butoxy tin and the like.

The β-diketone metal complex used in the present invention is preferably a metal complex of 2,2,6,6-tetramethylheptane-3,5-dione(DPM.H), 2,6-dimethyl-3,5-heptanedione(DMHD.H) or 2,4-pentanedione (acac.H) and specific examples thereof may include Sr(DPM)₂, Ba(DPM)₂, Mg(DPM)₂, Y(DPM)₃, La(DPM)₃, Pr(DPM)₃, Eu(DPM)₃, Gd(DPM)₃, Tb(DPM)₃, Dy(DPM)₃, Tm(DPM)₃, Ti(DPM)₂(iPrO)₂, Zr(DPM)₄, Hf(DPM)₄, Fe(DPM)₃, Ru(DPM)₃, Cu(DPM)₂, Al(DPM)₃, In(DPM)₃, Sn(DPM)₂, Pb(DPM)₂, Bi(DPM)₃, Mn(DPM)₂, Zn(DPM)₂, Sr(DMHD)₂, Ba(DMHD)₂, Mg(DMHD)₂, Y(DMHD)₃, La(DMHD)₃, Pr(DMHD)₃, Eu(DMHD)₃, Gd(DMHD)₃, Tb(DMHD)₃, Dy(DMHD)₃, Tm(DMHD)₃, Ti(DMHD)₂(iPrO)₂, Zr(DMHD)₄, Hf(DMHD)₄, Fe(DMHD)₃, Ru(DMHD)₃, Cu(DMHD)₂, Al(DMHD)₃, In(DMHD)₃, Sn(DMHD)₂, Pb(DMHD)₂, Bi(DMHD)₃, Mn(DMHD)₂, Zn(DMHD)₂, Sr(acac)₂, Ba(acac)₂, Mg(acac)₂, Y(acac)₃, La(acac)₃, Pr(acac)₃, Eu(acac)₃, Gd(acac)₃, Tb(acac)₃, Dy(acac)₃, Tm(acac)₃, Ti(acac)₄, Zr(acac)₄, Hf(acac)₄, Fe(acac)₃, Ru(acac)₃, Cu(acac)₂, Al(acac)₃, In(acac)₃, Sn(acac)₂, Pb(acac)₂, Bi(acac)₃, Mn(acac)₂, Zn(acac)₂ and their n-hydrate salts (n is a number of 1 or more).

The organometallic compounds may be used singly or in combination with two or more in accordance with objective fine metal oxide particles. The combined use of the organometallic compounds can prepare a phosphor, an electrically conductive material, a ferroelectric material, a catalyst, an abrasive, or the like.

The combination of two kinds of the organometallic compounds are as follows:

Using the combination of β-diketonate Y complex and β-diketonate Eu complex, red fluorescent fine particles of Y₂O₃:Eu can be prepared.

Using the combination of β-diketonate Y complex, β-diketonate Gd complex and β-diketonate Eu complex, red fluorescent fine particles of (Y, Gd) ₂O₃:Eu can be prepared.

Using the combination of β-diketonate Y complex, β-diketonate Gd complex, β-diketonate Eu complex and borate, red fluorescent fine particles of YBO₃:Eu(Y, Gd) BO₃:Eu can be prepared.

Using the combination of β-diketonate Y complex and β-diketonate Tb complex, green fluorescent fine particles of Y₂O₃:Tb can be prepared.

Using the combination of β-diketonate Zn complex, β-diketonate Mn complex and Si alkoxide, green fluorescent fine particles of Zn₂SiO₄:Mn can be prepared.

Using the combination of β-diketonate Al complex, β-diketonate Mg complex, β-diketonate Sr complex, β-diketonate Ba complex and β-diketonate Mn complex, green fluorescent fine particles of (Mg, Sr, Ba) Al₁₂O₉:Mn can be prepared.

Using the combination of β-diketonate Y complex and β-diketonate Tm complex, blue fluorescent fine particles of Y₂O₃:Tm can be prepared.

Using the combination of β-diketonate Al complex, β-diketonate Ba complex, β-diketonate Mg complex and β-diketonate Eu complex , blue fluorescent fine particles of (Ba, Mg) Al₁₀O₁₇:Eu can be prepared.

Using the combination of β-diketonate In complex and β-diketonate Sn complex, transparent conductive tin added indium oxide fine particles can be prepared.

Using the combination of β-diketonate Ba complex and Ti alkoxide, ferroelectric barium titanate fine particles can be prepared.

Using the combination of β-diketonate Pb complex, β-diketonate Zr complex and Ti alkoxide, ferroelectric lead zirconium titanate fine particles can be prepared.

The ferroelectric substance is an object having a high dielectric constant of several hundreds or more and causing spontaneous polarization.

Examples of the gaseous organometallic compounds may include ones obtainable by vaporizing a solid or liquid organometallic compound with heating, ones obtainable by vaporizing an organometallic compound solution with heating and a mixture thereof.

The gaseous organometallic compounds may be vapor of one kind of the organometallic compound or mixed vapor of two or more kinds of the organometallic compounds. Further, the mixed vapor of two or more kinds of the organometallic compounds may be prepared by mixing two or more kinds of the organometallic compounds followed by vaporization, or by vaporizing two or more kinds of the organometallic compounds followed by mixing.

In the case that metal alkoxide is used as the organometallic compound, as the metal alkoxide is easily hydrolyzed owing to a metal contained therein, it is decomposed before vaporization to induce a low yield and piping clogging occasionally. Accordingly, it is preferred to stabilize the metal alkoxide as a solution of an organic solvent and then vaporize.

In the case that the gaseous organometallic compound is prepared by vaporizing an organometallic compound solution with heating, it may contain vapor of one kind of the organometallic compound or vapor of two or more kinds of the organometallic compounds. When the gaseous organometallic compound is vapor of two or more kinds of the organometallic compounds, it may be prepared by vaporizing two or more kinds of the organometallic compound solutions and then mixing, or by vaporizing a solution containing two or more kinds of the organometallic compounds.

Examples of the solvent used in the organometallic compound solution herein may include at least one solvent selected from methyl alcohol, ethyl alcohol, propyl alcohol, butyl alcohol, tetrahydrofuran, dimethyl sulfoxide, dimethylformamide, hexane, cyclohexane, methylcyclohexane, dioxane, acetone, ethyl acetate, butyl acetate, methyl isobutyryl ketone, diethyl ether, t-butyl methyl ether, acetyl acetone, diisobutyryl methane, dipivaloyl methane and the like. These solvents may be used singly or in combination with two or more kinds. The concentration of the solution is not particularly limited.

In the present invention, an inert gas such as nitrogen and argon can be used as a carrier of the gaseous organometallic compounds.

Examples of the oxidizing substance used in the present invention may include oxygen, a mixed gas prepared by mixing oxygen with other gases, for example, an inert gas such as nitrogen and argon in an appropriate proportion, air, water and nitrous oxide. These oxidizing substances may be used singly or in combination with two or more.

Before the combustion of the organometallic compound, the gaseous organometallic compound and the oxidizing substance may be preheated respectively at a temperature lower than the temperature at which the organometallic compound is decomposed. Further, after the gaseous organometallic compound and the oxidizing substance are mixed, they may be preheated at a temperature lower than the temperature at which the organometallic compound is decomposed. Furthermore, the gaseous organometallic compound and the oxidizing substance may be mixed before combustion, or the gaseous organometallic compound may be heated at a temperature higher than the temperature at which the organometallic compound is decomposed, and may be released into the oxidizing substance and subjected to combustion while mixing with the oxidizing substance. In the case that the organometallic compound is in a liquid state or in a solution state dissolved in the organic solvent, the liquid organometallic compound, as it is, may be mixed with the oxidizing substance.

The organometallic compound and the oxidizing substance are desirably mixed in such a condition that they are in a complete mixing state. If the mixing thereof is insufficient undesirably, in the case that, for example, two or more kinds of the organometallic compounds are used, the composition of resulting fine metal oxide particles is occasionally heterogeneous because of insufficiency of mixing.

It is preferred to subject the gaseous organometallic compound and the oxidizing substance to combustion after mixing them. The combustion may be started by using an ignition source or by heating them at a temperature higher than the ignition point thereof.

The organometallic compound and the oxidizing substance are mixed insufficiently and thereby the organometallic compound is not completely burned to cause such problems that the quality and the particle diameters are not stable and the resulting particle diameters are mostly large because unreacted substances such as carbides, moisture and the like are remained and fine particle welds together owing to the prolonged reaction time.

The mixed gas prepared by mixing the oxidizing substance with the gaseous organometallic compound or the vaporized solution containing the dissolved organometallic compound preferably has an organometallic compound concentration in the range of explosion. The organometallic compound concentration out of the range of explosion is undesirable because the combustion is unstable. When the vapor pressure of the organometallic compound is low and the concentration thereof does not reach to the range of explosion, it is preferred to use a combustion improver. There is particularly no limitation on the combustion improver. For example, in the case of using the solution of the organometallic compound, the solvent of this solution can be a combustion improver.

The oxidizing substance is used in the oxygen molar amount required to completely oxidize the organometallic compound in the case of using the organometallic compound prepared by vaporizing a solid or liquid organometallic compound with heating, or in a molar amount of from 0.5 to 40 times, preferably 1 to 30 times, more preferably 1 to 20 times the oxygen molar amount required to completely oxidize the organometallic compound and the solvent in the case of using the gaseous organometallic compound prepared by vaporizing the organometallic compound solution with heating. When the amount of oxygen is too small, fine metal oxide particles produced are occasionally coagulated owing to unreacted starting materials. When the amount of oxygen is too large undesirably, the organic substance concentration becomes lower than the explosion limits and the combustion is unstable.

The combustion temperature in the present invention is preferably not lower than 400° C., particularly preferably from 500 to 1500° C. When the combustion temperature is low undesirably, unreacted starting materials or organic component are remained due to incomplete combustion. When the combustion temperature is too high undesirably, the apparatus lifetime is lowered and the contamination occurs due to deterioration of apparatus materials.

The fine metal oxide particles thus prepared have a number average particle diameter of not more than 100 nm, preferably 5 to 90 nm, more preferably 5 to 50 nm.

For example, in the case that the fine metal oxide particles having a particle diameter of not more than 100 nm are used for a phosphor, a catalyst, an abrasive, an electrically conductive transparent membrane or the like, the luminous strength, catalyst activity and polishing properties thereof are particularly excellent.

In the present invention, the number average particle diameter of the fine metal oxide particles is determined by a microscopic method with measurement of an electron microscopic image.

Next, the process for producing the fine metal oxide particles according to the present invention will be described with reference to the more specific embodiments.

As one embodiment of the process for producing the fine metal oxide particles of the present invention, there is a process for producing the fine metal oxide particles by mixing the gaseous organometallic compound and the oxidizing substance and subjecting the resulting mixture to combustion.

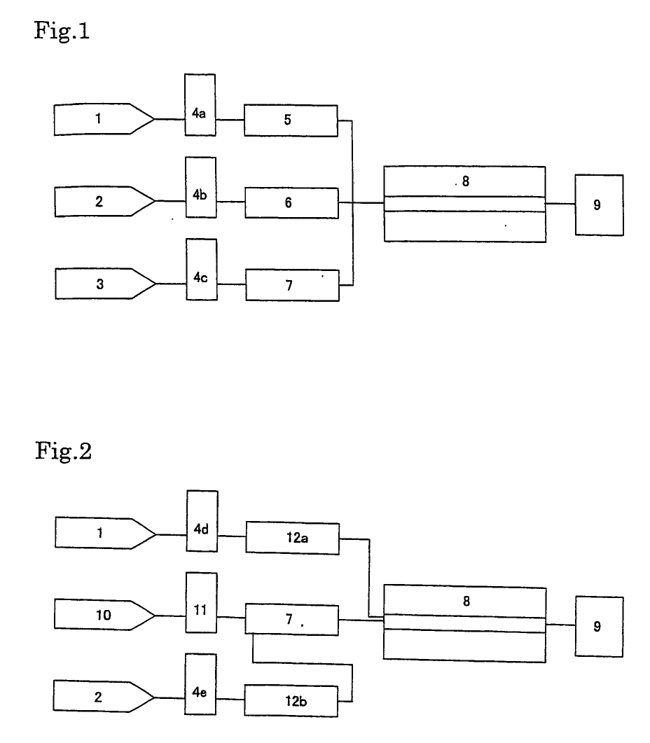

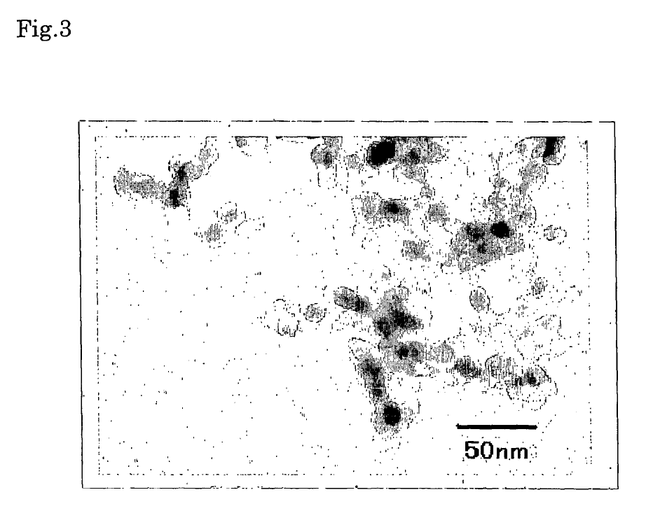

As a more specific process for producing the fine metal oxide particles by the above process, there is a process by means of, for example, an apparatus as shown in FIG. 1.

FIG. 1 is a schematic diagram showing one embodiment of a production apparatus used in the process for producing the fine metal oxide particles according to the present invention.

The organometallic compound is previously set in a heating vaporizer 6 and vaporized there. The organometallic compound is quantitatively fed to a tubular electric furnace 8 by quantitatively feeding a carrier gas 2 through a mass flow controller 4b to the heating vaporizer 6. The oxidizing substance 1 is quantitatively fed through a mass flow controller 4a to a preheater 5 and the oxidizing substance preheated is quantitatively fed to the tubular electric furnace 8. In the case of using two kinds of the organometallic compounds, two kinds of the organometallic compounds may be fed into the heating vaporizer 6, or the organometallic compound vaporized using a heating vaporizer 7 may be fed to the tubular electric furnace 8 by a carrier gas 3.

The gaseous organometallic compound mixed with the oxidizing substance in the tubular electric furnace 8 forms fine metal oxide particles by combustion. The formed fine metal oxide particles are collected by a collector 9.

As another embodiment of the process for producing the fine metal oxide particles according to the present invention, there is a process such that the organometallic compound solution and the oxidizing substance are mixed and the resulting mixture was vaporized with heating and thereafter the gaseous mixture is subjected to combustion to prepare the fine metal oxide particles.

In this process, for example, the mixture of the organometallic compound solution and the oxidizing substance is quantitatively fed to a combustion apparatus such as tubular electric furnaces or the like (for example, spray method). This mixture is vaporized with heating and the gaseous mixture is burned to form fine metal oxide particles. The formed fine metal oxide particles are collected by, for example, a collector.

In the case of using two or more kinds of the organometallic compounds, two or more kinds of the organometallic compound solutions each containing one organometallic compound may be individually fed into a heating decomposing apparatus, or a solution containing two or more kinds of the organometallic compounds may be fed to the heating decomposing apparatus.

As another example of the process for producing the fine metal oxide particles according to the present invention, there is a process of mixing the oxidizing substance with vapor containing the gaseous organometallic compound prepared by vaporizing the organometallic compound solution, and heating the mixture and thereby subjecting the gaseous organometallic compound to combustion, to prepare the fine metal oxide particles.

As a more specific process for producing the fine metal oxide particles by the above process according to the present invention, there is a process by means of, for example, an apparatus as shown in FIG. 2.

FIG. 2 is a schematic diagram showing another embodiment of a production apparatus used in the process for producing the fine metal oxide particles according to the present invention.

The organometallic compound solution 10 is quantitatively fed to a heating vaporizer 7 through a metering pump 11 and vaporized here. The vapor containing the gaseous organometallic compound vaporized in the heating vaporizer 7 is quantitatively fed to a tubular electric furnace 8 by quantitatively feeding a carrier gas 2 to the heating vaporizer 7 through a mass flow controller 4e. The oxidizing substance 1 is quantitatively fed to a preheater 12a through a mass flow controller 4d, and the preheated oxidizing substance 1 is quantitatively fed to a tubular electric furnace 8. In the case of using two kinds of the organometallic compounds, as the organometallic compound solution 10, the solution containing two or more kinds of the organometallic compounds may be used or plural means of vaporizing the organometallic compound solution and feeding them to the tubular electric furnace 8 may be provided.

The gaseous organometallic compound is fed to the tubular electric furnace 8 and mixed with the oxidizing substance, and then subjected to combustion, to form the fine metal oxide particles. The resulting fine metal oxide particles are collected by a collector 9.

In the above embodiments, as a combustion apparatus, the tubular electric furnace is used. However, in the present invention, any apparatus may be used without particular limitation as long as the gaseous organometallic compound can be burned by it.

### EXAMPLES

The present invention will be described in more detail with reference to the following examples below, but the present invention should not be limited by the examples.

The measurement of the number average particle diameter of the fine metal oxide particles was carried out by a microscopic method.

### Example 1

Fine metal oxide particles were prepared by using an apparatus as shown in FIG. 1.

To a vaporizer (6) heated at 230° C., a mixed solution of 90.5 g of Y(DPM)₃, 2.63 g of Eu(DPM)₃ and 217 g of methanol was fed at a flow rate of 4 mL/min and vaporized. The combustion temperature in a tubular electric furnace (8) was set to 800° C. Air (1) heated at 230° C. was flowed at a rate of 33.3 L/min and thereby gaseous Y(DPM)₃, Eu(DPM)₃ and methanol, and air were fed into the tubular electric furnace (8). The combustion time was 3 sec. The molar amount of oxygen in the air fed was 1.5 times the oxygen molar amount required for complete oxidization of a β-diketonate metal complex (Y(DPM)₃, Eu(DPM)₃) and methanol. As a result, the yield of red fluorescent fine particles of Y₂O₃:Eu collected in a collector (9) was 90%. The fine particles of Y₂O₃:Eu had an average particle diameter of 10 nm.

### Example 2

Fine metal oxide particles were prepared by using an apparatus as shown in FIG. 1.

To a vaporizer (6) heated at 230° C., a mixed solution of 49.5 g of Y(DPM)₃, 29.5 g of Gd(DPM)₃, 2.18 g of Eu(DPM)₃ and 188 g of methanol was fed at a flow rate of 4 mL/min and vaporized. The combustion temperature in a tubular electric furnace (8) was set to 800° C. Air (1) heated at 230° C. was flowed at a rate of 33.3 L/min and thereby gaseous Y(DPM)₃, Gd(DPM)₃, Eu(DPM)₃ and methanol, and air were fed into the tubular electric furnace (8). The combustion time was 3 sec. The molar amount of oxygen in the air fed was 1.5 times the oxygen molar amount required for complete oxidization of a β-diketonate metal complex (Y(DPM)₃, Gd(DPM)₃ and Eu(DPM)₃) and methanol. As a result, the yield of red fluorescent fine particles of (Y, Gd)₂O₃:Eu collected in a collector (9) was 91%. The fine particles of (Y, Gd)₂O₃:Eu had an average particle diameter of 10 nm.

### Example 3

Fine metal oxide particles were prepared by using an apparatus as shown in FIG. 1.

To a vaporizer (6) heated at 230° C., a mixed solution of 92.7 g of Y(DPM)₃, 1.03 g of Tb(DPM)₃ and 218 g of methanol was fed at a flow rate of 4 mL/min and vaporized. The combustion temperature in a tubular electric furnace (8) was set to 800° C. Air (1) heated at 230° C. was flowed at a rate of 33.3 L/min and thereby gaseous Y(DPM)₃, Tb(DPM)₃ and methanol, and air were fed into the tubular electric furnace (8). The combustion time was 3 sec. The molar amount of oxygen in the air fed was 1.5 times the oxygen molar amount required for complete oxidization of a β-diketonate metal complex (Y(DPM)₃ and Tb(DPM)₃) and methanol. As a result, the yield of green fluorescent fine particles of Y₂O₃:Tb collected in a collector (9) was 91%. The fine particles of Y₂O₃:Tb had an average particle diameter of 10 nm.

### Example 4

Fine metal oxide particles were prepared by using an apparatus as shown in FIG. 1.

To a vaporizer (6) heated at 230° C., a mixed solution of 39.2 g of Zn(acac)₂, 15.5 g of tetraethoxy silane, 0.63 g of Mn(DPM)₂, and 498 g of methanol was fed at a flow rate of 4 mL/min and vaporized. The combustion temperature in a tubular electric furnace (8) was set to 800° C. Air (1) heated at 230° C. was flowed at a rate of 33.3 L/min and thereby gaseous Zn(acac)₂, tetraethoxy silane, Mn(DPM)₂ and methanol, and air were fed into the tubular electric furnace (8). The combustion time was 3 sec. The molar amount of oxygen in the air fed was 1.5 times the oxygen molar amount required for complete oxidization of Zn(acac)₂, tetraethoxy silane, Mn(DPM)₂ and methanol. As a result, the yield of green fluorescent fine particles of Zn₂SiO₄:Mn collected in a collector (9) was 81%. The fine particles of Zn₂SiO₄:Mn had an average particle diameter of 50 nm.

### Example 5

Fine metal oxide particles were prepared by using an apparatus as shown in FIG. 1.

To a vaporizer (6) heated at 230° C., a mixed solution of 47.1 g of In(acac)₂, 2.78 g of Sn(DPM)₂ and 449 g of acac.H was fed at a flow rate of 4 mL/min and vaporized. The combustion temperature in a tubular electric furnace (8) was set to 800° C. Air (1) heated at 230° C. was flowed at a rate of 40.0 L/min and thereby gaseous In(acac)₂, Sn(DPM)₂ and acac.H , and air were fed into the tubular electric furnace (8). The combustion time was 3 sec. The molar amount of oxygen in the air fed was 1.5 times the oxygen amount required for complete oxidization of In(acac)₂, Sn(DPM)₂ and acac.H. As a result, the yield of tin oxide added indium oxide conductive fine particles collected in a collector (9) was 88%. The tin oxide added indium oxide fine particles had an average particle diameter of 50 nm.

### Example 6

Fine metal oxide particles were prepared by using an apparatus as shown in FIG. 1.

To a vaporizer (6) heated at 230° C., a mixed solution of 43.2 g of Ba(DPM)₂, 24.4 g of titanium tetraisopropoxide and 270 g of methanol was fed at a flow rate of 4 mL/min and vaporized. The combustion temperature in a tubular electric furnace (8) was set to 800° C. Air (1) heated at 230° C. was flowed at a rate of 33.3 L/min and thereby gaseous Ba(DPM)₂, titanium tetraisopropoxide and methanol , and air were fed into the tubular electric furnace (8). The combustion time was 3 sec. The molar amount of oxygen in the air fed was 1.5 times the oxygen amount required for complete oxidization of Ba(DPM)₂, titanium tetraisopropoxide and methanol. As a result, the yield of barium titanate fine particles collected in a collector (9) was 87%. The barium titanate fine particles had an average particle diameter of 30 nm.

### INDUSTRIAL APPLICABILITY

According to the present invention, high quality fine metal oxide particles having a uniform particle diameter can be prepared in a high yield without troublesome procedures.

1. A process for producing fine metal oxide particles which process comprises subjecting a gaseous organometallic compound to combustion in a gas phase in the presence of an oxidizing substance.

2. A process for producing fine metal oxide particles which process comprises mixing a gaseous organometallic compound with an oxidizing substance to prepare a mixture and subjecting the mixture to combustion.

3. A process for producing fine metal oxide particles which process comprises mixing an organometallic compound solution with an oxidizing substance to prepare a mixture, making the mixture into a gaseous state and then subjecting the gaseous mixture to combustion.

4. A process for producing fine metal oxide particles which process comprises mixing an oxidizing substance with a gaseous organometallic compound prepared by vaporizing an organometallic compound solution to prepare a mixture and then subjecting the mixture to combustion.

5. The process for producing fine metal oxide particles according to claim 1 wherein the oxidizing substance comprises at least one selected from an oxygen-containing gas, oxygen, water and nitrous oxide.

6. The process for producing fine metal oxide particles according to claim 1 wherein a combustion improver is used in the combustion of the organometallic compound and the oxidizing substance.

7. The process for producing fine metal oxide particles according to claim 3 wherein the solvent of the organometallic compound solution is a combustion improver.

8. The process for producing fine metal oxide particles according to claim 1 wherein the organometallic compound comprises at least a metal, a carbon and a hydrogen atom.

9. The process for producing fine metal oxide particles according to claim 1 wherein the organometallic compound comprises at least one compound selected from an alkyl metal compound, a metal alkoxide and a β-diketone metal complex.

10. The process for producing fine metal oxide particles according to claim 9 wherein an alkyl group of the alkyl metal compound has 1 to 10 carbon atoms.

11. The process for producing fine metal oxide particles according to claim 9 wherein the metal alkoxide is a metal methoxide, ethoxide, n-propoxide, i-propoxide, n-butoxide, sec-butoxide, tert-butoxide or t-amyloxide.

12. The process for producing fine metal oxide particles according to claim 9 wherein the β-diketone metal complex is a metal complex of 2,2,6,6-tetramethylheptane-3,5-dione, 2,6-dimethyl-3,5-heptanedione or 2,4-pentanedione.

13. The process for producing fine metal oxide particles according claim 3 wherein the solvent of the organometallic compound solution is at least one solvent selected from methyl alcohol, ethyl alcohol, propyl alcohol, butyl alcohol, tetrahydrofuran, dimethyl sulfoxide, dimethylformamide, hexane, cyclohexane, methylcyclohexane, dioxane, acetone, ethyl acetate, butyl acetate, methyl isobutyryl ketone, diethyl ether, t-butyl methyl ether, acetyl acetone, diisobutyryl methane and dipivaloyl methane.

14. The process for producing fine metal oxide particles according to claim 1 wherein the combustion temperature is not lower than 400° C.

15. The process for producing fine metal oxide particles according to claim 1 wherein the oxidizing substance is used in a molar amount of from 0.5 to 40 times the molar amount of oxygen required for complete oxidization of the organometallic compound and the solvent of the organometallic compound solution.

16. The process for producing fine metal oxide particles according to claim 1 wherein the fine metal oxide particles produced have a number average particle diameter of not more than 100 nm.

17. The process for producing fine metal oxide particles according to claim 1 wherein the fine metal oxide particles produced are phosphors.

18. The process for producing fine metal oxide particles according to claim 17 wherein the phosphor is at least one red phosphor selected from Y₂O₃:Eu, (Y, Gd)₂O₃:Eu, YBO₃:Eu and (Y, Gd)BO₃:Eu.

19. The process for producing fine metal oxide particles according to claim 18 wherein the boron source of YBO₃:Eu or (Y, Gd)BO₃:Eu is a borate.

20. The process for producing fine metal oxide particles according to claim 17 wherein the phosphor is at least one green phosphor selected from Y₂O₃:Tb, Zn₂SiO₄:Mn and (Mg, Sr, Ba)Al₁₂O₁₉:Mn.

21. The process for producing fine metal oxide particles according to claim 17 wherein the phosphor is at least one blue phosphor selected from Y₂O₃:Tm and (Ba, Mg)Al₁₀O₁₇:Eu.

22. The process for producing fine metal oxide particles according to claim 1 wherein the fine metal oxide particles produced are conductive materials.

23. The process for producing fine metal oxide particles according to claim 22 wherein the conductive materials comprise tin oxide or tin oxide added indium oxide.

24. The process for producing fine metal oxide particles according to claim 1 wherein the fine metal oxide particles produced are ferroelectric substances.

25. The process for producing fine metal oxide particles according to claim 24 wherein the ferroelectric substances comprise barium titanate, strontium titanate, lead titanate, barium strontium titanate, lead zirconium titanate, lead lanthanum zirconium titanate or strontium bismuth tantalum oxide.

26. The process for producing fine metal oxide particles according to claim 4 wherein the solvent of the organometallic compound solution is a combustion improver.

27. The process for producing fine metal oxide particles according to claim 4 wherein the solvent of the organometallic compound solution is at least one solvent selected from methyl alcohol, ethyl alcohol, propyl alcohol, butyl alcohol, tetrahydrofuran, dimethyl sulfoxide, dimethylformamide, hexane, cyclohexane, methylcyclohexane, dioxane, acetone, ethyl acetate, butyl acetate, methyl isobutyryl ketone, diethyl ether, t-butyl methyl ether, acetyl acetone, diisobutyryl methane and dipivaloyl methane.
